(19) United States
(12) Patent Application Publication
(10) Pub. No.: US 2013/0074692 A1
(43) Pub. Date: Mar. 28, 2013

(54) METHOD FOR THE ELECTRIC DEPOSITION OF AEROSOLS AND DEVICE FOR PERFORMING THE METHOD

(71) Applicants: Christian Lübbert, Langensendelbach (DE); Ulrich Riebel, Briesen (DE); Sergiy Lebedynskyy, Cottbus (DE)

(72) Inventors: Christian Lübbert, Langensendelbach (DE); Ulrich Riebel, Briesen (DE); Sergiy Lebedynskyy, Cottbus (DE)

(21) Appl. No.: 13/127,536

(22) PCT Filed: Nov. 4, 2009
(86) PCT No.: PCT/EP2009/007911

§ 371 Date: Oct. 16, 2012

(30) Foreign Application Priority Data
Nov. 4, 2008 (DE) 102008055732.3

(51) Int. Cl. B03C 3/34

(52) U.S. Cl. CPC B03C 3/34
USPC 95/74; 95/79; 96/65; 96/69

(57) ABSTRACT

The invention relates to a process for the separation of charged aerosols, in which the aerosol is, first of all, separated in a collector electrode, which can be flowed through under the effect of a space charge. For the production of a high electrical potential, electrical charges of the aerosol to be separated are subsequently collected on the collector electrode. Finally, the residual aerosol exiting from the collector electrode is guided through the separation zone at high field intensity. In accordance with the invention, the invention also relates to a device for the implementation of the above-stated process.

The invention relates to a multi-stage process for the electrical separation of aerosols with net charges through the use of space charge effects.

Two-stage electrostatic separators have been known for a long time (such as U.S. Pat. No. 2,129,783—Jul. 26, 1938) and are used, above all, in air conditioning technology, as well as for the separation of oil mists.

In the first stage, the aerosol particles are charged by a corona discharge between a generally wire-shaped discharge electrode and a generally plate-shaped precipitation electrode and are partially separated, whereby the dwell time between the electrodes is, as a rule, too short for a complete separation of the aerosol.

In the second stage, the residual aerosol, which is now electrically charged, passes between separation electrodes which are positioned in parallel and are generally plate-shaped. In an alternate manner, every second separation electrode is connected to or grounded with high voltage, as the case may be, so that a strong electrical field is applied between the separation electrodes and . . .

. . . the charged particles are drawn to one of the electrodes and are separated. During the second stage, there is no corona discharge, so that only a very low current intensity is required here for the supply of high voltage power.

A continuous further development of two-stage electrostatic separators has taken place in recent decades, whereby a number of these further developments should be considered in additional detail for differentiation from the invention presented here. It must thereby be first noted that charging the particles represents the essential process in the first stage of the two-stage electrostatic separator, which is not an integral component of the invention.

U.S. Pat. No. 4,861,356 describes a two-stage electrostatic separator, in which the problem of electrical flashovers between the separation electrodes is solved through the fact that, first of all, a movable compressed air nozzle is provided for the purging of the intermediate electrode spaces and that, secondly, a very high-ohm series resistor is provided between the high voltage power supply and each one of the separation electrodes that is to be placed under high voltage. This series resistor is, in accordance with the invention, implemented by a corona discharge between a tip or wire electrode under high voltage and the plate to be electrified. For that purpose, the plates to be electrified project forward somewhat in relation to the grounded plates (0.25 inch=6.5 mm).

U.S. Pat. No. 4,264,343 describes a two-stage electrostatic separator assembly, which contains grounded precipitator electrodes penetrating in parallel. The first stage is implemented by double-tip discharge electrodes under high voltage, whereby each of the two tips is directed at the electrified separation electrodes of the second stage. Each of these separation electrodes, however, is encased in a dielectrical insulation layer and separately connected to a high voltage power supply. Thus, the discharge electrodes here have no function in the adjustment of the potential of the separation electrodes.

Also, the use of space charges for the separation of electrically charged aerosol particles is not fundamentally new.

U.S. Pat. No. 4,029,482 describes a separator, in which aerosols are first of all charged by a corona discharge and then pass through a fiber filter or a porous filling made from an electrically insulating material. Electrical forces on the aerosol particles, which move them transversely to the flow and deposit them in the filter, thereby arise through the space charge effect. The separation of particles is markedly increased in relation to the use of a non-insulating filter material.

DE 101 32 582 describes an electrostatic separator, in which the aerosol, which has previously been electrically charged, is, for the purpose of separation, guided through a bundle of tubes positioned parallel to the direction of flow. The tubes are sprayed with water and are thus grounded by contact with the wall of the apparatus, regardless of the choice of material. The use of tubes with differently structured internal surfaces and with spiral-shaped components is proposed. In this case, too, the separation is carried out primarily through the space charge effect in the tubes, though not explicitly mentioned. The separation is further improved by a filter downstream.

The known technical solutions for the use of space charges for the separation of aerosols have a number of serious disadvantages that result from the unfavorable constructions, which do not take the physics of space charges into consideration:

If the electrical field intensities that arise from the space charge in a tube or filter that is flowed through are considered, then the following equation, in which E is the electrical field intensity, A is the surface area and V is the volume of an aerosol, while ∈₀ is the dielectricity constant and ρ₁ is the space charge density, applies:

$$\int E \partial A = \frac{1}{{ɛ}_{0}} \int {ρ}_{i} \partial V$$

This means, first of all, that, upon an evenly distributed space charge density, the electrical field intensity of the central axis or the center of the tubes or filter increases linearly outwardly. On the other hand, the field intensity in the center of the tubes or filter is very low, so that the charged aerosol particles undergo no electrical forces here and are not, therefore, separated. Thus, in both of the constructions mentioned, there is a partial flow of the aerosol, which passes through the center of the assembly practically without separation.

Secondly, in accordance with the current standards, very high levels of separation effects, of 99% and more, are generally required, so that the aerosol concentration, and thereby the space charge density as well, must decrease correspondingly greatly over the migration distance of the aerosol through the tubes or the filter layer. With decreasing space charge density, however, the field intensity that is present also drops proportionately. Thus, the mass flow of particles in a vessel or a tube or a pore, as the case may be, is separated under the effect of the space charge (upon a charge of the individual particles present) in proportion to the square of the concentration of the particles. It is thus evident that no sufficiently low concentrations of aerosol in the clean gas can be achieved with reasonable equipment expense.

The task of using separation supported by space charges, improved both fundamentally and significantly by means of an improved design principle, for the separation of aerosols thus arises.

The task is solved by means of a process with the characteristics of claim 1.

The invention thereby proceeds from the fact that the aerosol is already charged in a unipolar manner by means of a preceding process, such as a corona discharge or a conventional electrostatic separation, for example. A suitable charging, which is not necessarily unipolar, however, can also be produced by means of other processes, such as by means of a . . .

. . . pneumatic transport or a dry atomization, for example. It is crucial for the aerosol to bear a net charge, at least in overall terms.

The basic idea is now as follows:

In a first step, a large charge quantity is collected through the space charge separation of a portion of the aerosol. This first step is preferably carried out in an electrically conductive hollow body, the collector electrode (CE), because the release of the aerosol charges through separation on the wall of the collector electrode (analogously to a Faraday cup) is not thereby influenced or impeded by the electrical potential of the collector electrode. Some technically suitable implementations of a hollow body, for example, are as follows:
A tube that is open and flowed through on both sides;
Two (or more) parallel plates electrically connected with one another, through the intermediate space of which the aerosol flows;
A cup or bell open on one side, into which the aerosol is blown;
A hollow body of the type described above with perforated partitions made from perforated metal plates, screen cloths, fill materials, etc.;
Cylindrically-shaped, cup-shaped, or plate-shaped parts of a filling volume, which are flowed through by the aerosol.

The space charge of the aerosol currently contained in the collector electrode, and the charge of the aerosol particles separated in the collector electrode, together produce a very high electrical potential of the collector electrode that increases still further over time.

In the second step, the charge quantity collected is used to produce a strong electrical field, in which the concentrated residual aerosol, which likewise still supports electrical charges but is too small for an efficient space charge separation, can be separated.

There are different variations of this as well:
The collector electrode is connected in an electrically conductive manner with a field electrode (FE) positioned downstream, and the field arises between the field electrode or field electrodes, as the case may be, and one or more precipitation electrode (NE).
The collector electrode acts at the same time as a field electrode, since the residual aerosol is guided between the outer side of the collector electrode and a grounded precipitation electrode or a grounded casing.

The hollow body (the collector electrode), which is electrically conductive but is insulated in relation to the casing of the installation, however, can, in many cases, also be replaced by a non-conductive hollow body without significant losses of function if the residual aerosol to be separated in the second step can once again be led past and directly to the collector electrode with the space charges contained and separated. This is always the case, therefore, if the collector electrode and the field electrode are spatially united as with the second alternative described above.

Since the separation of the charged aerosol particles in the collector electrode, which is dependent on space charges, proceeds regardless of the potential of the collector electrode, the collector electrode can reach extremely high electrical potentials of 100 kV and more, which can otherwise only be produced by means of expensive high voltage generators. On the other hand, flashovers between the collector electrode and the grounded installation casing must necessarily occur after a certain operating time. Because of the very high electrical conductivity of the flashover channel, a complete discharge, or even (because of the induction effect) a transient charge reversal of the collector electrode, would thereby occur. Moreover, damage to the device and the emission of electromagnetic interference pulses could also occur. Thus, the invention provides a device that limits the electrical potential of the collector electrode to a value that is clearly below the flashover voltage. A corona discharge path, which is constructed in a non-sensitive and . . .

. . . very simple manner, and the discharge voltage (corona inception voltage), [AI] which can be adjusted within a very broad range, is particularly well suited to this purpose. The corona discharge path can be located either outside the separation space (on the high voltage insulator for the suspension of the collector electrode and field electrode, for example), or even inside the separation space (that is to say, between the collector electrode or field electrode and the grounded casing wall). The latter has the advantage that the current flowing through the corona can be used for an additional charging of the aerosol on the input to the 2nd stage. Of course, fluctuations in the temperature, or in the composition of the as to be cleaned, can then also lead to fluctuations of the potential on the collector electrode.

If the collector electrode/field electrode is intended to be operated at very high potential values, then it may be reasonable to replace the corona discharge path with a corona cascade—that is to say, a cascade of individual corona discharge paths.

Also, the particular functionality of the separation supported by autogenic space charges (ARA) must be taken into consideration for the cleaning process. The danger thereby exists that an equalization of potential between the collector electrode/field electrode and the ground will come about through the cleaning, or that aerosol that has surrendered its charges to the collector electrode will enter into the current again. Separation supported by autogenic space charges is thus particularly suitable for the separation of fluid aerosols that move away from the collector electrode. Solid aerosols can also be separated and cleaned by the collector electrode, however, since the dust layer on the collector electrode is liquefied, either occasionally or continuously, and removed by a fluid spray brought into the aerosol. In addition, other types of cleaning, such as cleaning with a compressed air jet, for example, are also conceivable. A mechanical cleaning can also come about through the transfer . . .

. . . of force impulses by means of the suspension insulators of the collector electrode/field electrode or insulating slide hammers. A possible aerosol discharge can thereby be prevented through the blocking of the aerosol stream during the cleaning.

On the whole, the efficiency of the process fundamentally depends on the quality of the insulation, and on the fact that the aerosol-borne electrical current is sufficiently high to balance out the charge outflow through the insulators that support the collector electrode and the field electrode. Thus, this process is provided, in particular, for use directly behind the point of production of the charge (corona chargers, electrically supported nebulization, mills, etc.). Upon low or highly fluctuating aerosol concentrations, a highly charged auxiliary aerosol can be produced (such as through electrical nebulization of a fluid, for example) in order to introduce a sufficient current onto the field electrode.

Additional characteristics, details and advantages of the invention emerge from the embodiments that are explained by means of the diagrams.

FIGS. 2 to 5 show different implementations of the basic idea.

FIG. 2 shows a particularly simple preferred method of construction for the cleaning of small- and medium-volume streams. A portion of the incoming electrically-charged aerosol 1 flows through the tubular collector electrode 3, and is in turn partially separated therein. The electrical potential accumulated on the collector electrode by the particle separation produces high electrical field intensities between the collector electrode 3 and the precipitation electrode 5. The aerosol flowing between the collector electrode and the precipitator electrode is already well cleaned in the first stage, while the partially cleaned gas 10 exiting from the collector electrode contains still higher concentrations of particles. In order to also clean this aerosol completely, the high potential of the collector electrode 3 is conveyed to the field electrode 4 by a conductive connection 11. The aerosol, which was incompletely cleaned in the first stage, is now, in the second stage, generally exposed to the high field intensity between the field electrode and the precipitation electrode 5, and exits from the separator as . . .

. . . a clean gas 2. The precipitation electrode 5 here is, at the same time, the casing 18.

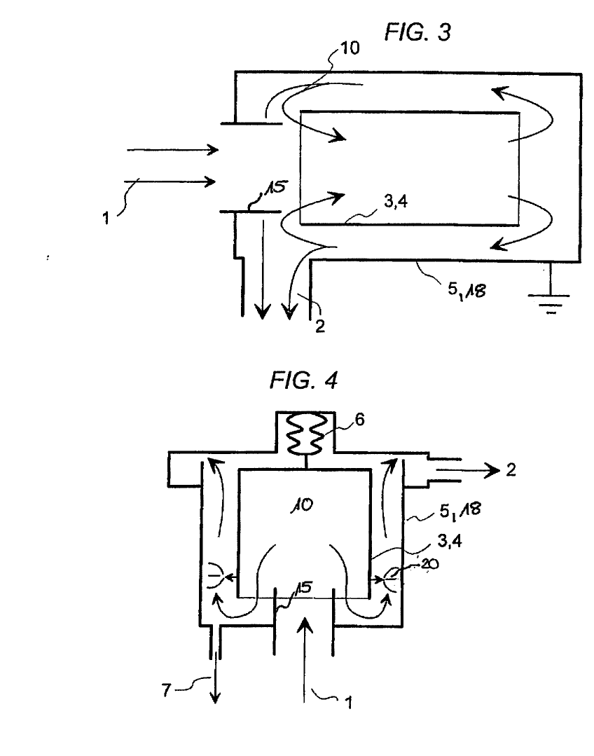

FIG. 3 depicts a particularly compact method of construction which appears, above all, to be suitable for small volume streams. The second cleaning stage is implemented here through an aerodynamic return of the aerosol. The collector electrode 3 and the field electrode 4 are thereby united in one electrode. The charged raw aerosol 1 enters into the apparatus through a nozzle 15 as a propulsion stream at high speed, so that the partially cleaned aerosol 10 flows back through the intermediate space between the field electrode and the casing. In order to guarantee a reliable function, a portion of the clean gas 2 should be recirculated in the raw gas current.

The functionality of the separator in accordance with FIG. 4 is comparable. Also, during a mixing of raw gas 1 and partially cleaned aerosol 10 within the interior of the collector electrode/field electrode 3, 4, which is constructed as a bell-shaped mixing tank, a sufficiently high potential arises, which then leads to a very high separation in the external space between the mixing tank and the casing 18. In addition, corona tips 20 are depicted on the outer side of the bell here, through which about the potential is limited to avoid flashovers. The corona can be used here for the additional charging of the aerosol used. The fluid aerosol separated can flow out through a discharge opening 7.

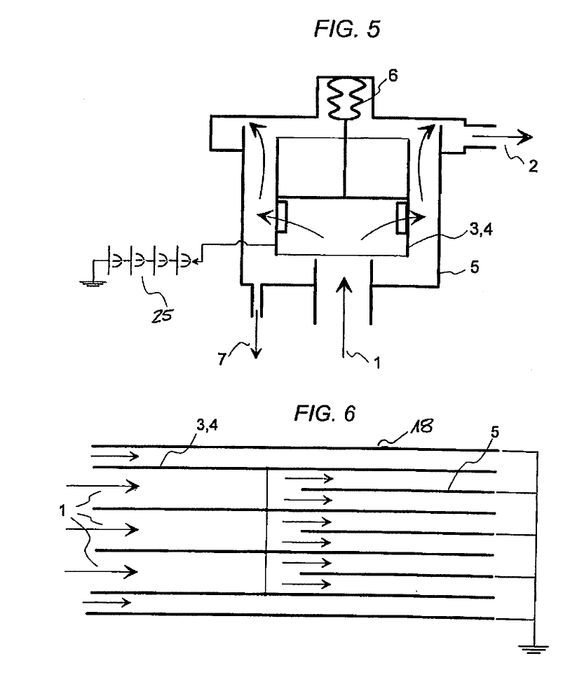

FIG. 5 depicts a construction similar to FIG. 4. Here, however, the charged aerosol flows through the collector electrode/field electrode 3, 4. In this case, the discharge of the collector electrode/field electrode takes place with the help of a corona discharge cascade 25.

FIG. 6 depicts a preferred type of construction for the cleaning of large aerosol volume streams. The collector electrode/field electrode consists of a large number of plates 3, 4, such as four, for example, which are electrically connected with one another in order to balance out possible differences in potential. In the part of the separator positioned upstream, these plates act as collector electrodes that are charged by the charged . . .

. . . raw aerosol 1. In the part of the separator located downstream, the plates act as field electrodes in relation to the precipitation electrodes 5 placed between the same. Also, the plates 3, 4 act as field electrodes in relation to the casing 18, so that the gas passed between the plates and the casing is also completely freed of the charged aerosol particles. Through the charges collected, a strong electrical field is produced between the collector electrode/field electrode 3, 4 and the precipitation electrode 5.

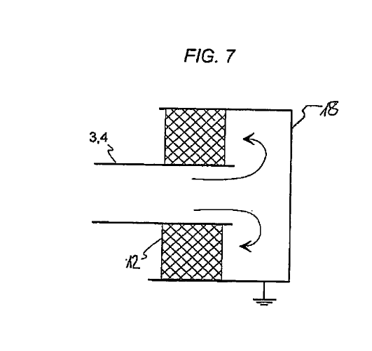

One additional possibility consists of using a non-conductive packing as a collector electrode/field electrode. FIG. 7 depicts a construction in which a cylindrical packing is flowed through from the interior. The insulating tube length 3, 4 that is attached as a collector electrode functions at the same time as a field electrode that produces a high electrical field intensity in the non-conductive packing 12. The packing offers the advantage that the particles to be separated only have to travel a short way to a surface. Instead of a packing, a filling of non-conductive filling units or an assembly of concentric tubes can also be used.

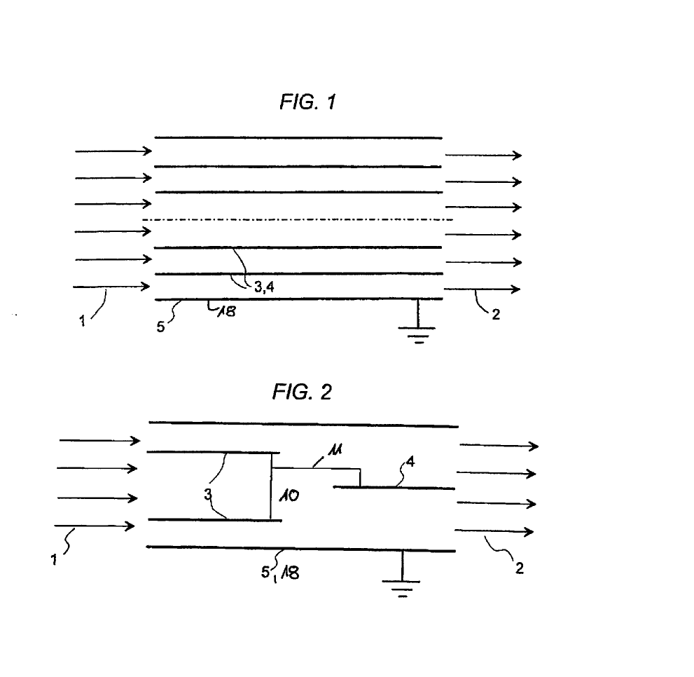

FIG. 1 depicts an arrangement that does not fall within the invention.

In FIG. 1, the charged aerosol 1 flows through an assembly of three concentric cylinders. Deposition only takes place inside the innermost cylinder through the effect of the space charge, whereby a high charge density collects on the outer side of the cylinder. A high field intensity thereby arises in the intermediate space between the innermost and the middle cylinder, through which aerosol is separated on the interior wall of the middle cylinder. A reinforced separation likewise comes about between the middle and the outside cylinder through the field of the middle cylinder. The disadvantage of this very simple arrangement is that the aerosol flowing through the internal cylinder is only exposed to slight field intensities, and is thus only incompletely separated.

1. A process for the separation of charged aerosols in a two-stage electrostatic separator with at least one collector electrode and at least one field electrode, comprising the following steps:
partial separation of partially separating the aerosol in the collector electrode, which can be flowed through under the effect of space charges;
collecting the electrical charge of the aerosol separated for the production of a very high electrical potential on the collector electrode;
if necessary, transferring the electrical potential to a field electrode; and
channeling the residual aerosol exiting from the collector electrode through the separation zone with high field intensity, which is constructed between the collector electrode and/or the field electrode and a grounded precipitation electrode.

2. A process in accordance with claim 1, wherein the collector electrode and/or the field electrode is cleaned with fluid.

3. A process in accordance with claim 1, wherein the discharge of the collector electrode and/or the field electrode takes place in a controlled manner.

4. A process in accordance with claim 3, wherein the controlled discharge of the collector electrode and/or the field electrode is carried out with the help of a corona discharge cascade.

5. A process in accordance with claim 1, wherein an auxiliary aerosol is used for the delivery of the charge.

6. A process in accordance with claim 1, wherein a second cleaning stage is carried out so that the aerosol is returned in an aerodynamic manner.

7. A device for the implementation of a process in accordance with claim 1, with a collector electrode that can be flowed through and a field electrode and grounded precipitation electrode that can be flowed through, wherein a separation zone with high field intensity is constructed between the collector electrode and/or the field electrode and a grounded precipitation electrode.

8. A device in accordance with claim 7, wherein the collector electrode and/or the field electrode is implemented in a plate-type type of construction.

9. A device in accordance with claim 7, wherein packing is used as a collector electrode and/or as a field electrode.
the collector electrode and/or the field electrode is implemented in a tube type of construction.

10. A device in accordance with claim 7, wherein a nozzle is coordinated with the collector electrode and/or the field electrode, through which nozzle the charged raw aerosol can be guided at high speed, as a propulsion stream, in the direction of the collector electrode and/or the field electrode.

11. A device in accordance with claim 10, wherein the collector electrode and the field electrode are united in one electrode.

12. A device in accordance with claim 9, wherein the collector electrode and/or the field electrode is implemented in a mixing tank type of construction.

13. A device in accordance with claim 7, wherein the collector electrode and/or the field electrode is conductive.

14. A device in accordance with claim 7, wherein the collector electrode and/or the field electrode is non-conductive.

15. A device in accordance with claim 7, wherein a non-conductive packing is used as a collector electrode and/or as a field electrode.

16. A process in accordance with claim 2, wherein the discharge of the collector electrode and/or the field electrode takes place in a controlled manner.

17. A process in accordance with claim 16, wherein the controlled discharge of the collector electrode and/or the field electrode is carried out with the help of a corona discharge cascade.

18. A process in accordance with claim 17, wherein an auxiliary aerosol is used for the delivery of the charge.

19. A process in accordance with claim 16, wherein an auxiliary aerosol is used for the delivery of the charge.

20. A process in accordance with claim 4, wherein an auxiliary aerosol is used for the delivery of the charge.
